(19) United States
(12) Patent Application Publication
(10) Pub. No.: US 2024/0072319 A1
(43) Pub. Date: Feb. 29, 2024

(54) METHOD AND APPARATUS FOR MONITORING ELECTRIC VEHICLES

(71) Applicant: Lee Edington, Terre Haute, IN (US)

(72) Inventor: Lee Edington, Terre Haute, IN (US)

(21) Appl. No.: 18/458,253

(22) Filed: Aug. 30, 2023

Related U.S. Application Data
(60) Provisional application No. 63/402,617, filed on Aug. 31, 2022.

(51) Int. Cl. H01M 10/48; G01J 5/00; G01J 5/02

(52) U.S. Cl. CPC H01M 10/486; G01J 5/0003; G01J 5/0096; G01J 5/028

(57) ABSTRACT

A method and apparatus for monitoring a battery pack of an electric vehicle includes positioning at least a portion of a monitoring apparatus under the electric vehicle. The monitoring apparatus has a camera, such as a thermal imaging camera, and a display that is adapted to display information relative to images, such a thermal images, captured by the camera in real-time via a communication link. The monitoring apparatus has and an elongated arm that is adapted to position the camera under the battery pack. The display is monitored external the vehicle while the user can manipulate the arm to position the camera subjacent the battery pack.

### CROSS REFERENCE TO RELATED APPLICATION

The present application claims the benefit of U.S. Pro. App. Ser. No. 63/402,617, filed on Aug. 31, 2022, which is incorporated herein by reference in its entirety.

### TECHNICAL FIELD AND BACKGROUND

The present disclosure is directed to a method and apparatus that allows the complete battery pack of an electric vehicle to be sensed, and optionally visualized, and managed without the need for jacking the vehicle or requiring the responder to lay adjacent to or under the vehicle.

Standard electric vehicles have a high voltage battery pack that is mounted and may form part of the vehicle sub-frame, typically under the floor and between the axles. These battery packs often have thousands of individual cells within them, as well as a flammable electrolyte solution. A slight movement in a cell may allow for the anode and cathode to touch, and the energy to build within the area. This energy has nowhere to dissipate. Therefore, a heating process known as stranded energy may occur, and pressure and heat can build. Once the pressure and/or heat reach the stage to ignite the electrolyte solution, a fire could ignite across the cells and the vehicle can become fully engulfed. Electric vehicles have been known to ignite weeks after the instance. This is due to energy slowly building.

The standard operating procedure for first responders is to jack up the vehicle and the battery casing with a thermal image unit. A standard EV battery casing is 5.5 inches off the ground with the tires inflated. When a fire occurs and the tires deflate, the battery casing is no more than about 2.5 inches off ground. This makes a dangerous situation for first responders to be jacking up a vehicle and lying next to a thermal imaging unit. Even after the vehicle is turned over to secondary responders, such as tow operators, the vehicle should be inspected at least daily by jacking up the vehicle and examining the battery casing with a thermal imaging unit.

### SUMMARY

When a fire ignites from the stranded energy of an electric vehicle battery pack, it will normally capture anything in proximity. Sensing and/or visualizing stranded energy before a fire occurs is important for all responders, and anyone who is involved with the vehicle.

A method and apparatus for monitoring a battery pack of an electric vehicle, according to an aspect of the invention, includes positioning a monitoring apparatus at least partially under the vehicle. The monitoring apparatus has a camera, such as a thermal imaging camera, and a display that is adapted to display information, such as thermal images captured by a thermal imaging camera in real-time via a communication link. The monitoring apparatus has and an elongated arm, such as a pole, which is adapted to position the thermal imaging camera. The display is monitored external the vehicle while manipulating the arm to position the camera subjacent the battery pack.

The arm may include a hinged portion so that the display can be positioned at an elevated position relative to the thermal imaging camera wherein the monitoring can occur while a person holding the monitoring apparatus is standing adjacent the vehicle. The display may be supported at one end of the arm opposite to another end of the arm that supports the thermal imaging camera. The vehicle may remain sitting on the ground during the monitoring.

These and other objects, advantages, purposes and features of this invention will become apparent upon review of the following specification in conjunction with the drawings.

### BRIEF DESCRIPTION OF THE DRAWINGS

FIG. 1 is a perspective view of a monitoring apparatus according to an embodiment of the invention shown in use monitoring a battery of an electric vehicle;

FIG. 2 is the same view as FIG. 1 with the monitoring apparatus full visible; and

FIG. 3 is a perspective view of the monitoring apparatus in FIGS. 1 and 2 shown in a folded storage configuration.

### DESCRIPTION OF THE PREFERRED EMBODIMENTS

The apparatus and method will now be described with reference to the accompanying figures, wherein the numbered elements in the following written description correspond to like-numbered elements in the figures.

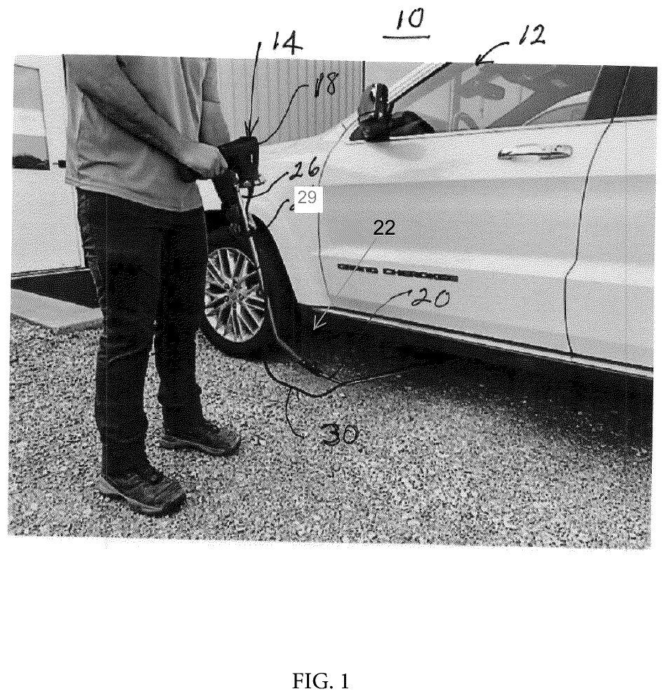

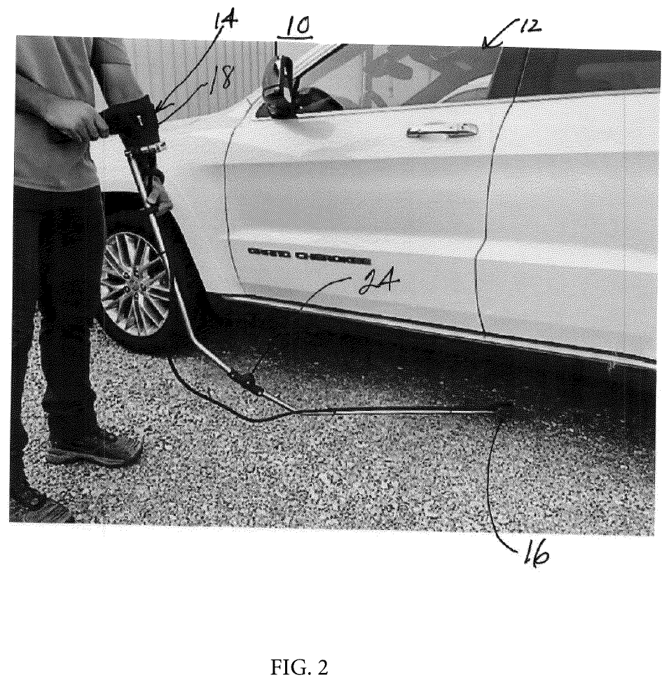

A method 10 of monitoring a battery pack of an electric vehicle 12 includes positioning at least a portion of a monitoring apparatus 14 under the vehicle (FIGS. 1 and 2). Monitoring apparatus 14 has at least one thermal imaging camera 16 that has a low enough vertical profile to fit in the space under vehicle 12 without the need to jack the vehicle off of the ground. It should be understood that multiple cameras may also be used, including digital cameras. The camera, as well as the display noted below, may be powered by an onboard battery, including an on board rechargeable battery, or powered via a 110-volt power source via a cable. The battery may be co-located with the display or the thermal imaging camera 16. For example, the onboard battery may be removable and plug in the display where the added weight will not impact the maneuverability of the camera.

Monitoring apparatus 14 may further include a display 18 that is configured to display information, such as parameters associated with the thermal images, such as temperature, and also time and date of when the thermal images were captured by camera 16. The information could be in alpha or alphanumerical or numerical form or an indication—for example, lights, such as colored LEDS, which that display or indicate the information, such as temperature, as well as date and time of when the battery was sensed or viewed. The monitoring device may also have a digital camera to provide visual digital images of the battery pack. In one embodiment, the display may simply comprise a light that indicates that the battery is above a designated threshold temperature. If the light is illuminated, the illuminated light indicates it is above the designated threshold temperature.

Monitoring apparatus 14 further includes an elongated arm 20, such as a pole, physically interconnecting camera 16 and display 18. Arm 20 is of a length that allows the operator to position camera 16 under vehicle 12 at the location of the vehicle's high voltage battery pack (not shown) while the operator is able to observe display 18 and be informed about the status of the battery pack without needing to lay down on the ground adjacent the vehicle or even needing to bend over extensively. Moreover, the camera 16 may be positioned by the arm 20 to be aligned under the footprint of the battery pack and, hence, vertically aligned with the battery pack and, therefore, can read the whole battery pack, which can provide a more accurate assessment of the state of the vehicle battery pack.

A communication channel 30 is provided between and interconnects the camera 16 and the display 18 and allows communication, such as images and/or data to be transmitted from camera 16 for display in real-time by display 18. Such communication channel 30 may be a cable but could alternatively be an RF channel, and infrared channel or other wireless communication. In the illustrated embodiment, camera 16 and display 18 are commercially available such as model VS290 supplied by Flir Corporation and are interconnected via the cable. When employing a cable, and to keep the cable secure and to avoid any tripping hazards, the cable may be supported externally on the arm using cable clips, for example, or maybe internally mounted and passed through channels formed in the hinge so that the majority, if not all, the cable is located internally within arm 20.

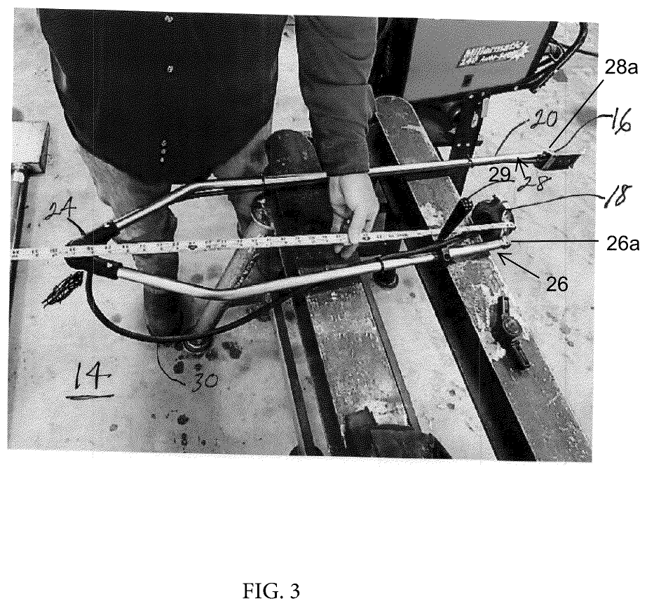

In use, the operator is shown in FIG. 1 monitoring display 18 while the operator remaining external vehicle 12 while manually manipulating arm to position the camera 16 juxtaposed with the battery pack. As is shown in FIGS. 1 and 2, arm 20 may have two portions joined by a hinge 24. The hinge 24 allows the arm 20 to fold for storage and to unfold into an L-shaped configuration when in use. The L-shaped configuration allows the operator to remain in a standing position adjacent the vehicle while monitoring display 18 and while also being able to position the camera 16 under the vehicle and subjacent to the vehicle battery pack, without needing to elevate the vehicle, such as show in FIG. 1. The hinge 24 may be located at a generally central portion 22 in order to allow arm 20 to be folded between a storage position shown in FIG. 3 and one or more in use positions, such as shown in FIGS. 1 and 2. Optionally, the hinge 24 may have essentially infinite positioning between the stowed and use positions or it may have defined positions between the stowed and use positions, such as by using detents on the components forming the hinge. Further, the hinge may have a manually operable lock, such as a pin, to fix the orientation of the hinge and configuration of the arm.

It should be understood that the monitoring apparatus 14 may include one or more actuators and input and power source, such as the online battery noted below, to control the actuator. For example, the hinge may include a rotary motor to fold or unfold the arm, which could be powered via a power circuit that is coupled via a switch to the onboard battery of the monitoring apparatus 14. In another example, as noted below, the arm may include a telescoping portion in addition to, or instead, of the hinge, which includes a linear or rotary actuator to extend or contract the telescoping portion via a power circuit that is coupled via a switch to the battery of the monitoring apparatus 14. In this manner, each actuator has a binary state—on or off. Alternately, the switch may comprise a variable or multi position switch to provide greater control over the speed and adjustment of the actuator.

Display 18 is supported at an end portion 26 of arm 20 that is opposite to another end portion 28 of the pole that supports camera 16. For example, display 18 may be mounted at the end 26a of arm 20 and form the end of monitoring apparatus 14. Similarly, the camera may be mounted at end 28a of arm and form the opposed end of monitoring apparatus 14.

To ease handling of monitoring apparatus 14, monitoring apparatus 14 may include an operator support handle 29 mounted or formed at or relative to end portion 26 of the arm for the convenience of the operator. Optionally the handle may be foldable or otherwise reconfigurable between a use configuration and a stowed configuration.

As noted, elongated arm 20 may be formed from a pole, and may be made from a variety of rigid materials, such as a metal, including aluminum, stainless steel; wood; fiberglass; or the like or a combination of materials. As an alternative, or in addition, to hinge 24 arm 20 may include a telescoping arm section to lengthen and shorten arm 20 to facilitate placement of camera 16.

Optionally, monitoring apparatus 14 may also include a sensor that detects when the camera is properly aligned with the battery pack and may be coupled to a light or other display that indicates when the camera is properly aligned with the battery pack.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A method of monitoring a battery pack of an electric vehicle, said comprising:
providing a monitoring apparatus having a thermal imaging camera and a display that is adapted to display information based on thermal images captured by the thermal imaging camera in real-time via a communication link, the monitoring apparatus having and an elongated arm, the arm adapted to allow positioning by a person of the thermal imaging camera under the vehicle to view the battery pack;
positioning at least a portion of the monitoring apparatus under the vehicle; and
monitoring the display external to the vehicle while manipulating the arm to position the camera subjacent the battery pack.

2. The method as claimed in claim 1 wherein said positioning includes positioning the display at an elevated position relative to the thermal imaging camera wherein the monitoring can occur while a person holding the monitoring apparatus is standing.

3. The method according to claim 2, wherein the arm includes a hinged portion, and said positioning includes adjusting the arm configuration about the hinged portion to position the thermal imaging camera under the vehicle while allowing a person to view the display while standing adjacent the vehicle.

4. The method as claimed in claim 1, further comprising supporting the display at a first end portion of the arm.

5. The method according to claim 4, further comprising supporting the thermal imaging camera at a second end portion of the arm opposed from the display.

6. The method as claimed in claim 1, further comprising positioning the vehicle so that it is sitting on the ground during said positioning.

7. An electric vehicle monitoring apparatus, the electric vehicle having a battery pack and a space under the battery pack when the vehicle is sitting on the ground, said electric vehicle monitoring apparatus comprising:
a thermal imaging camera having a vertical profile less than the space under the electric vehicle when sitting on the ground; and
a display that is adapted to display information based on thermal images captured by the thermal imaging camera in real-time via a communication link, said electric vehicle monitoring apparatus having an elongated arm, the arm adapted to allow a person to position the thermal imaging camera subjacent the battery pack.

8. The electric vehicle monitoring apparatus according to claim 7, wherein said information includes thermal images captured by the thermal imaging camera.

9. The electric vehicle monitoring apparatus according to claim 7, wherein said elongated arm is configured to be reconfigurable between a stowed configuration and an in use position.

10. The electric vehicle monitoring apparatus according to claim 9, wherein said elongated arm includes a hinge to allow said arm to fold or be folded between the stowed configuration and an in use configuration.

11. The electric vehicle monitoring apparatus according to claim 10, wherein said elongated arm includes a central portion, and said hinge mounted to said central portion of said arm.

12. The electric vehicle monitoring apparatus according to claim 7, wherein said elongated arm comprises an elongated pole.

13. The electric vehicle monitoring apparatus according to claim 7, further comprising a handle mounted relative to said elongated arm.
